(19) United States
(12) Patent Application Publication
(10) Pub. No.: US 2006/0240766 A1
(43) Pub. Date: Oct. 26, 2006

(54) Efficient broadcast and multicast transmission over shared downlink channels

(75) Inventor: Andreas Wilde, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/406,293

(22) Filed: Apr. 19, 2006

(30) Foreign Application Priority Data
Apr. 20, 2005 (DE) 102005018455.3

(51) Int. Cl. H04H 1/00

(52) U.S. Cl. 455/3.01

(57) ABSTRACT

Method for transmission of broadcast- and/or multicast-data within a mobile communication system, preferably according to HSDPA technology (High Speed Downlink Packet Access), wherein the communication system has a multitude of mobile terminals (UE) is characterized in that—regarding a high level of efficiency of data transmission—selectable terminals (UE) within a radio cell of the communication system are combined as a group of terminals (UE) and that the group of terminals is assigned a common group identifier which serves as destination address for the data transmission.

### BACKGROUND OF THE INVENTION

1. Field of the Invention

The present invention relates to a method for transmission of broadcast- and/or multicast-data within a mobile communication system, preferably according to HSDPA technology (High Speed Downlink Packet Access), wherein the communication system has a multitude of mobile terminals.

2. Description of the Related Art

Thanks to the development of UMTS, mobile communication systems have gained a tremendous popularity in different areas over the last few years. In this context, in particular third generation networks, so called 3G networks, have to be mentioned. See 3GPP TS25.211 V5.6.0 (2004-09) (4.1.2.7, 5.3.3.12, 5.3.3.13), 3GPP TS25.212 V5.9.0 (2004-06) (4.5), 3GPP TS2 5.214 V5.10.0 (2004-12) (6A), and 3GPP TS25.331 V5.12.1 (200 5-03) (8.5.25).

Even though there are developments in very different directions, today there is only very limited support of broadcast and multicast transmissions in modern mobile communication systems. The main reason for the correspondingly limited capabilities of communication systems is that common channels, which can be received by all users in a radio cell, are designed for only a limited data throughput, whereas higher data rates are usually sent over specifically dedicated channels which can be received by one user only. The individual channels as defined in 3G networks according to the UMTS standard UTRA-FDD (UMTS Terrestrial Radio Access Frequency Division Duplex), are depicted in FIG. 3. The channels already mentioned—common channel and dedicated channel—are formed as downlink channel, i.e. for the data transmission from a network-side base station (node B) to a receiver node, as well as an uplink channel in the reverse direction. The receiver nodes which are in general mobile terminals, for example a mobile phone or a laptop, will in the following be generally referred to as terminals or UEs (User Equipment).

In addition to the mentioned channels, shared channels have been defined in order to improve the efficiency of high speed data transmission. Such a technology in 3GPP is for example HSDPA (High Speed Downlink Packet Access). The shared channels are always allocated to a certain number of users together. Though, the problem is that every data transmission over a shared channel—and also if this channel is used by different users together—is only targeted to one user individually.

A message flow as used for transmissions with HSDPA is shown in FIG. 4. Over a control channel (HS-SCCH, High Speed-Shared Control Channel) the receiver node is informed about a data transmission scheduled in the future. The actual data transmission is performed via a shared channel (HS-PDSCH, High Speed Physical Downlink Shared Channel). To do so, the HS-DSCH (High Speed Downlink Shared Channel) transport channel is mapped on the HS-PDSCH. The respective feedback signals (ACK, NACK or CQI), which the receiver node sends after the data transmission to the node B, are transferred via a dedicated uplink channel (HS-DPCCH, High Speed Dedicated Physical Control Channel).

As it becomes obvious from FIG. 4, the transmission via HSDPA comprises a retransmission of data in case the original transmission has failed. In this context, it is disadvantageous that in existing mobile systems multiple physical transmissions of the same data are necessary if these are to be transmitted via a shared channel to two or several users in the same radio cell.

On the other hand there are special broadcast systems, as for example DVB (Digital Video Broadcast), which are optimized in the sense that they send the same data only once via a broadcast channel which can be received by all subscribed users (e.g. ETSI EN 302 304 V1.1.1 (2004-11)). Normally, such systems do not comprise any feedback channels and, moreover, in general, they do not enable any dedicated connection to specific users. A combination of the mentioned broadcast services with others, for example interactive services, is very difficult and complex and will normally require the interworking with other systems like UMTS.

### SUMMARY OF THE INVENTION

The present invention is based on the task to design and further develop a method of the above mentioned kind according to which a high level of efficiency for the data transmission is achieved with easy means.

According to the invention, the task mentioned above is solved by a method showing the characteristics of patent claim 1. According to the latter, a method for transmission of broadcast- and/or multicast-data in a mobile communication system of that kind mentioned at the beginning is designed and further developed in such a way that selectable terminals within a radio cell of the communication system are combined as a group of terminals and that the group of terminals is assigned a common group identifier which serves as destination address for the data transmission.

According to the invention, it has first been recognized that the efficiency of the data transmission can be increased considerably if the same data within a radio cell of the communication system is not to be sent individually to all the terminals. According to the invention, a grouping of selectable terminals within a radio cell of the communication system is proposed. In a way further according to the invention, this group of terminals is assigned a common group identifier. This group identifier replaces the individual identifiers of the individual terminals and serves as destination address for the data transmission. Due to the method according to the invention, the number of necessary transmissions is reduced significantly, and by doing so, other capacities/bandwidths of the system which are free, i.e. available for other applications, are drastically increased.

In case of HSDPA, the identifier, which is assigned to the individual terminals and which is in general 16 bits long, is referred to as H-RNTI (HS-DSCH—Radio Network Temporary Identifier). Within a radio cell, a terminal can be identified unambiguously by this identifier, i.e. data packets can be delivered to the correct terminal. When changing from one radio cell to another, the terminal is assigned a new H-RNTI. Following the naming of this terminology, the group identifier assigned to the group of terminals, will be referred to as HG-RNTI (HS-DSCH Group—RNTI). The HG-RNTI is used for the delivery of data packets to the corresponding group of UEs, so that all the UEs of one group to which the shared HG-RNTI is assigned to, receive all the data packets targeted to the corresponding group.

Regarding a particularly high efficiency, it can be provided that the same data is only sent once per group. Due to the usage of the HG-RNTI it is ensured that the data is received by all the terminals of the group.

Regarding a particularly simple implementation it can be provided that one of the individual identifiers H-RNTI of one of the terminals of the group is used as group identifier being assigned to a group of terminals. In an advantageous way the data transmissions from the network are coordinated in such a way that each data transmission can be received by all the terminals in one group by respecting the characteristics of the individual terminals, in particular their UE capabilities (for example HSDPA category) and the radio conditions. In order to avoid unnecessarily high transmission power, it is provided in an advantageous way that the data transmission power is adjusted to that terminal of the group having the worst radio conditions. In general, this will be one of the terminals being positioned near to the radio cell border.

The feedback channels, i.e. for the uplink control traffic over HS-DPCCH (High Speed-Dedicated Physical Control Channel) can be operated in normal HSDPA mode, i.e. every terminal is assigned an individual H-RNTI. This means, however, that the group of terminals which is assigned a common HG-RNTI should not be chosen too large since otherwise the data traffic over the uplink channel would increase significantly due to feedback transmissions, which are proportional to the number of users.

In case of a failed data transmission, which the terminals indicate to node B in general by a NACK feedback, it can be provided in an advantageous manner that the shared HG-RNTI of the terminals of the group again serves as destination address for the new data transmission.

Regarding the reduction of the uplink traffic it can be provided that the CQI (Channel Quality Indicator) messages of UEs with good radio conditions are sent at longer intervals provided they only receive HG-RNTI transmissions. Regarding a further reduction of the uplink data traffic, the transmission of NACK packets (No ACKnowledgement) can—alternatively or in addition—be restricted or completely omitted. The network can be configured in such a way that it automatically assumes a NACK message if it does not receive an ACK message. A further reduction of the feedback data traffic could be achieved by defining another uplink channel than HS-DPCCH which would allow the grouping of ACK/NACK messages, similar to a shared channel.

In the context of a concrete embodiment, the group of terminals can be divided into subgroups. The subgroups can be chosen in such a way that basically those UEs to which the original transmission was not successful, are in a subgroup to which the data is retransmitted. Such a grouping could for example be performed dynamically and dependent on the radio conditions of the individual terminals. The advantage of such a grouping into subgroups results from the fact that those UEs which have received the original message successfully do not have to generate any feedback traffic in the context of a repeated data transmission. This reduces the feedback traffic on the uplink channel and furthermore, results in power savings of the respective terminals.

In the context of another concrete embodiment an intelligent transition mechanism from a ptm (point to multipoint) to a ptp (point to point) data transmission can be provided for. Here, the ptm transmission would use the HG-RNTI and the ptp transmission would use the H-RNTI. Since ptp as well as the ptm transmission use the same HS-PDSCH, the transition between these two transmissions could happen very quickly. Such a transition mechanism would allow switching specific UEs—i.e. those with bad radio conditions—to ptp mode. Furthermore, it can be envisaged to form several smaller HG-RNTI groups with terminals in similar radio conditions. In case some of the UEs are at the border of the radio cell, a transmission in ptp mode using a dedicated channel with soft-handover gain can further improve the efficiency of the data transmission. Under certain circumstances a transition into or from the ptm mode over common channels can improve the data transmission.

In an advantageous way, the first transmission to the whole group of UEs, would take place, where the transmission power is not adjusted to the UEs with the worst radio conditions. By doing so, some of the UEs would not successfully receive the first transmission. For a retransmission to these UEs, either a subgroup would be formed or the transmission to these UEs would be performed in ptp mode. Here, parts of the information of the first transmission would be used taking advantage of the HARQ method (Hybrid Automatic Repeat Request) in order to keep the amount of data for retransmission low. For this purpose, the HARQ process would be maintained when switching from ptm mode to ptp mode. The advantage of the proposed idea is that the overall transmission power for all the UEs in that group is kept lower by sending the first transmission with low transmission power and re-transmitting subsequently in ptp mode than sending the first transmission with such a high transmission power that would allow all the UEs to receive the message error-free at once.

This method can also be applied by first performing retransmissions in ptm mode before retransmitting in ptp mode.

In an advantageous way, the usage of a modified HS-PDSCH can be provided which is in particular suitable for MBMS transmissions (Multimedia Broadcast/Multicast Service). Such a modification could for example be realized by a longer TTI (Transmission Time Interval), by more powerful coding and/or modulation schemes.

Finally, it can be envisaged to apply the mentioned principles also to the uplink data transmission and in particular to provide a grouping of the destination address with a common group identifier for the uplink data traffic. Such measures prove to be in particular beneficial when a terminal transmits the same contents to different base stations or—in peer-to-peer-mode—directly to other terminals.

Now, there are several options of how to design and to further develop the teaching of the present invention in an advantageous way. For this purpose, it must be referred to the claims subordinate to claim 1 on the one hand and to the following explanation of a preferred example of an embodiment of the method according to the invention together with the figure on the other hand. In connection with the explanation of the preferred embodiment of the invention and the figure, generally preferred designs and further developments of the teaching will also be explained. In the drawing,

### BRIEF DESCRIPTION OF THE DRAWINGS

FIG. 1 shows in a schematic drawing a radio cell of a communication system where the method according to the invention is performed,

FIG. 2 shows in a schematic drawing a time diagram for the transmission of data to terminals via a shared downlink channel,

FIG. 3 shows in a schematic drawing a conventional configuration of channels in a mobile communication system and

FIG. 4 shows in a schematic drawing a conventional message flow for transmissions via a shared channel.

### DETAILED DESCRIPTION OF THE PREFERRED EMBODIMENTS

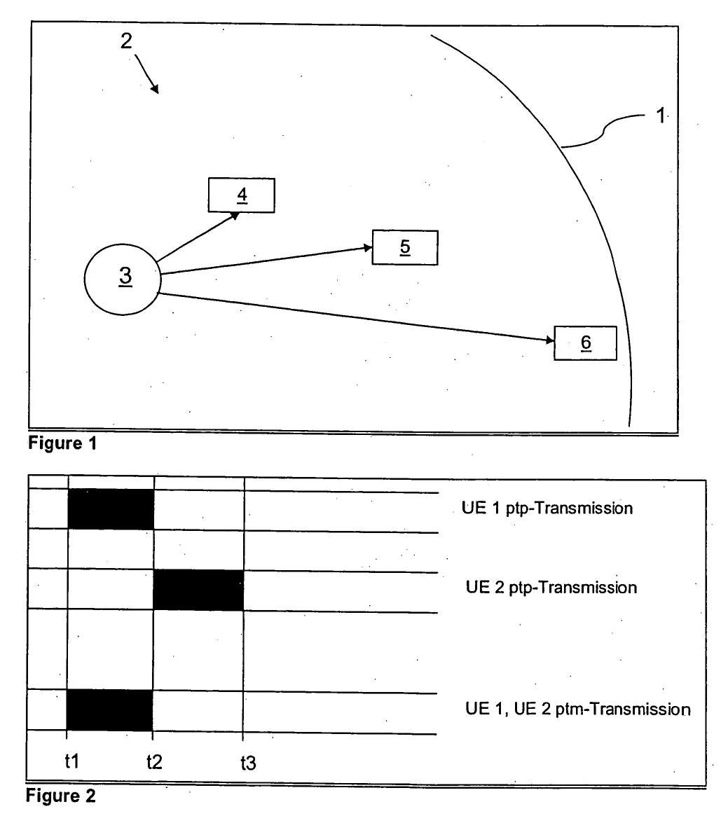

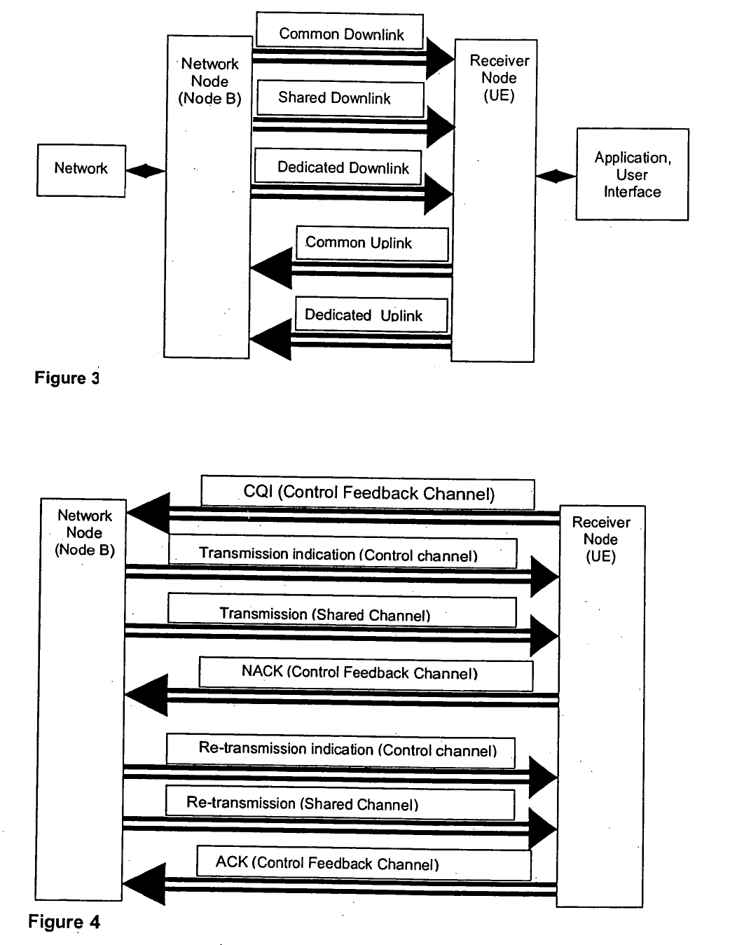

FIG. 1 shows—schematically—a radio cell 1 of a mobile communication system 2 comprising a network node 3—node B—as well as a multitude of mobile devices 4, 5, 6, of which for reasons of clarity only three are depicted. The mobile devices 4, 5, 6 can for example be mobile phones, laptops, palmtops etc. Each of theses terminals 4, 5, 6 is assigned an individual identifier (H-RNTI) by which the terminal 4, 5, 6 can unambiguously be identified within the radio cell 1.

In a way according to the invention, the terminals 4, 5, 6 are combined into one group which is assigned a common group identifier (HG-RNTI). According to the invention, for a broadcast- and/or multicast-data transmission from node B 3 to the terminals 4, 5, 6 not the individual identifiers H-RNTI of the individual terminals 4, 5, 6 are used, but the common group identifier HG-RNTI.

Due to its positioning at the radio cell border 1, the terminal 6 will in general have the worst radio conditions. The transmission power with which the network node 3 sends data over the shared channel, will therefore be adjusted to terminal 6. The network node 3 gets related information about the radio conditions of the individual terminals 4, 5, 6 by the CQI messages which are transmitted via HS-DPCCH.

FIG. 2 shows schematically a time diagram depicting the data transmission to two terminals—UE 1 and UE 2—over a shared downlink channel. In the upper part of the diagram the situation for a transmission in ptp mode is depicted. For the transmission of data to UE 1 the downlink channel is used from time t1 until t2. Subsequently, the downlink channel is needed for the transmission to UE 2 until time t3. When performing the transmission in ptm mode, though, as depicted in the lower part of FIG. 2, the downlink channel is only used between time t1 and t2. Between t2 and t3 the channel is free and can be used for the transmission of other data. The more terminals acting as receivers of data to be transmitted exist, the more efficiently the downlink channel will be used.

Regarding further advantageous designs of the teaching according to the invention and in order to avoid repetitions it is referred to the general part of the description as well as to the attached claims.

Finally, it is particularly important to point out that the example of an embodiment of the teaching according to the invention from above only serves as an illustration of the teaching as according to the invention, but that it does by no means restrict the latter to the given example of an embodiment.

1. A method for transmission of broadcast- and/or multicast-data within a mobile communication system, preferably according to HSDPA technology (High Speed Downlink Packet Access), wherein the communication system has a multitude of mobile terminals, wherein selectable terminals within a radio cell of the communication system are combined as a group of terminals and that the group of terminals is assigned a common group identifier which serves as destination address for the data transmission, wherein the data transmission is performed only once per group.

2. The method according to claim 1, wherein an individual identifier of one of the terminals of a group is used as group identifier assigned to that group of terminals.

3. The method according to claim 1, wherein the characteristics of the individual terminals of the group are respected when transmitting data.

4. The method according to claim 1, wherein the data transmission power is adjusted to the terminal of the group with the worst radio conditions.

5. The method according to claim 1, wherein uplink control data transmissions on HS-DPCCH (High Speed-Dedicated Physical Control Channel) are provided like in normal HSDPA operation.

6. The method according to claim 1, wherein a retransmission of data is performed due to a failed data transmission by using the group identifier.

7. The method according to claim 1, wherein CQI (Channel Quality Indicator) messages of terminals of the group with good radio conditions are sent at longer time intervals.

8. The method according to claim 1, wherein the transmission of NACK packets (No ACKnowledgement) is restricted or completely omitted.

9. The method according to claim 1, wherein the group of terminals is divided into subgroups.

10. The method according to claim 2, wherein the group of terminals is divided into subgroups.

11. The method according to claim 8, wherein the group of terminals is divided into subgroups.

12. The method according to claim 9, wherein the grouping is made dynamically depending on the radio conditions of the individual terminals.

13. The method according to claim 10, wherein the grouping is made dynamically depending on the radio conditions of the individual terminals.

14. The method according to claim 11, wherein the grouping is made dynamically depending on the radio conditions of the individual terminals.

15. The method according to claim 1, wherein an intelligent transition mechanism switches from ptm (point to multipoint) to ptp (point to point) data transmission.

16. The method according to claim 15, wherein those terminals of the group with bad radio conditions, are switched to ptp mode.

17. The method according to claim 16, wherein by taking advantage of the HARQ (Hybrid Automatic Repeat Request) method when switching between ptm mode and ptp mode, the transmission power for the transmissions in ptm mode is selected to be smaller than it would be necessary for a successful reception by those terminals with the worst radio conditions.

18. The method according to claim 1, wherein a modified HS-PDSCH (High Speed-Physical Downlink Shared Channel) is used.

19. The method according to claim 9, wherein a modified HS-PDSCH (High Speed-Physical Downlink Shared Channel) is used.

20. The method according to claim 12, wherein a modified HS-PDSCH (High Speed-Physical Downlink Shared Channel) is used.

21. The method according to claim 17, wherein a modified HS-PDSCH (High Speed-Physical Downlink Shared Channel) is used.

22. The method according to claim 18, wherein the modification is based on a longer TTI (Transmission Time Interval), on stronger coding and/or on higher modulation schemes.

23. The method according to claim 19, wherein the modification is based on a longer TTI (Transmission Time Interval), on stronger coding and/or on higher modulation schemes.

24. The method according to claim 20, wherein the modification is based on a longer TTI (Transmission Time Interval), on stronger coding and/or on higher modulation schemes.

25. The method according to claim 21, wherein the modification is based on a longer TTI (Transmission Time Interval), on stronger coding and/or on higher modulation schemes.

26. The method according to claim 1, wherein a grouping of the destination addresses with a common group identifier is also used for the uplink data transmission.

27. The method according to claim 2, wherein a grouping of the destination addresses with a common group identifier is also used for the uplink data transmission.

28. The method according to claim 9, wherein a grouping of the destination addresses with a common group identifier is also used for the uplink data transmission.

29. The method according to claim 12, wherein a grouping of the destination addresses with a common group identifier is also used for the uplink data transmission.

30. The method according to claim 17, wherein a grouping of the destination addresses with a common group identifier is also used for the uplink data transmission.
